(19) United States
(12) Patent Application Publication
(10) Pub. No.: US 2007/0143030 A1
(43) Pub. Date: Jun. 21, 2007

(54) Computer implemented method for aligning flexible molecules by performing ensemble alignment in the internal coordinate space followed by rigid body alignment in cartesian space

(76) Inventors: Robert D. Clark, Creve Coeur, MO (US); Edmond Abrahamian, Richmond Heights, MO (US); Alexander Strizhev, Simi Valley, CA (US)

Correspondence Address: LAURENCE A WEINBERGER, ESQ., 429 EXTON COMMONS, EXTON, PA, 19341, US

(21) Appl. No.: 11/495,996

(22) Filed: Jul. 27, 2006

Related U.S. Application Data
(60) Provisional application No. 60/702,816, filed on Jul. 27, 2005.

(51) Int. Cl. G06F 19/00

(52) U.S. Cl. 702/19; 702/20

(57) ABSTRACT

A method is disclosed that overcomes the problem in the prior art of requiring the use of a template or base molecule in order to compare the three dimensional configurations of molecules. The disclosed method teaches that the requirement for a template can be eliminated by handling the components of configuration—conformation versus rotation and translation in three-dimensional space—separately. The internal coordinate (torsional) space is explored first using a multi-objective genetic algorithm to minimize strain while maximizing steric and pharmacophoric concordance. Optimal overlays in Cartesian space are then obtained by applying a 3D hypermolecule construction method that makes use of linear assignment to identify optimal feature correspondences between ligands.

Benefit of Provisional Application No. 60/702,816 filed on Jul. 27, 2005 is hereby claimed.

### FIELD OF THE INVENTION

The invention disclosed in this patent document generally concerns the computational chemistry analysis of chemical entities to aid in the determination of the likelihood that they could lead to the development of pharmaceutical compounds. More specifically the present invention concerns methods to align molecular structures in three dimensional space so that meaningful comparisons of structure can be made.

### BACKGROUND OF THE INVENTION

Aligning a set of flexible and biologically active small molecules in three dimensions is key to drug discovery and development.^{1,2} In principle, the advent of computer programs for in silico docking could fulfill this need. Unfortunately, many drug development targets are membrane-bound proteins not readily amenable to crystallization, and many of the crystal structures that are available do not reflect the tertiary structure relevant to ligands of interest. Moreover, existing scoring functions for in silico docking are often inadequately reliable even when good target structures are available and induced fit interactions between ligands and protein do not complicate matters.

Alignment methods can operate either in a limited conformational space or by torsional sampling of the full range of conformations that are energetically accessible. The DISCO program exemplifies the former approach, whereas GASP is a good example of the latter. The performance of these two programs were recently critically compared with each other and with the corresponding functions in Catalyst.³ Each had strengths and weaknesses, but none performed well across the board.

Each program approaches the problem somewhat differently. DISCO starts from ensembles of discrete conformations generated by systematic search. The spatial disposition of pharmacophoric features in each is abstracted into a graph in which nodes are colored by feature type and edges are colored by length. Clique detection is then used to find maximal subgraphs shared by at least one conformation of each ligand, each such subgraph constituting a pharmacophore hypothesis.^{4,5} This approach assumes that all ligands share exactly the same pharmacophoric interaction pattern, which may not always be correct. “Partial coverage” solutions, which “hit” some but not all ligands, are therefore problematic. In principle, every possible subset of the ligands under consideration can be considered separately. In practice, doing so is usually prohibitively time consuming. No account is taken of steric overlap.

DISCO defines a final search query as a set of pairwise distance constraints. Converting these into a set of Cartesians coordinates (spatial constraints) requires that a specific set of features satisfying those constraints be identified in one of the ligands, and a search run to make sure that this candidate spatial query is in fact satisfied by the other ligands. Depending on the mix of distances and feature types, however, a common subgraph may fit more than one distinct query in Cartesian space—in particular, a four-point pharmacophore will, in general, be chiral, and the common subgraph may arise from different “epimers” in different ligands. Such false solutions must be discarded, though doing so greatly reduces the overall effectiveness of the program for complex pharmacophores involving flexible molecules.

GASP⁶ uses a genetic algorithm (GA) operating on two classes of genes for each model considered. One class is composed of torsional angles for each rotatable bond in each ligand stored in Gray-coded format. Genes in the second class map features from each ligand onto features in a template ligand. Each candidate model's chromosome is decoded by applying the coded torsions, then applying a Procrustes transformation that translates and rotates each ligand onto the template so as to minimize the least-squares error with respect to the specified mapping. The fitness of each overlay is evaluated as a weighted average of terms reflecting the energy, pharmacophoric consistency and volume overlap; the second and third terms are evaluated with respect to the template. Each generation is derived from the one that came before by application of standard cross-over and mutational operators; because the torsions are Gray coded, single-bit inversions yield an approximately Gaussian distribution of torsional mutations.

The SEAL program was originally designed to overlay pairs of rigid structures,⁷ but has subsequently been extended to allow for ligand flexibility by linking local minimization with discrete sampling of the global conformational space.⁸ Optimal alignment was defined as a maximal overlap in atom-centered electrostatic and steric “fields”, with Gaussian pseudo-energy functions used in both cases to simplify calculations and to minimize the number of local minima in the solution space. A similar approach is taken in Field Fit alignment for comparative molecular field analysis (CoMFA),⁹ with Lennard-Jones and Coulombic potentials used in place of Gaussian fields.

Other methodologies have been taken more or less directly from protein docking. FlexS¹⁰ is probably the most prominent example of this. The program starts by finding similar rigid fragments pairs, taking one fragment from each of two ligands. These are overlaid based on the triplet of pharmacophoric features in one that best match a triplet in the other. The rest of each ligand is then built up fragment by fragment, with torsions chosen from a torsional library derived from literature crystal structures so as to maximize the steric and pharmacophoric compatability between the ligands. A branch-and-prune strategy is used to avoid combinatorial explosion potential implicit in this strategy. SurflexSim¹¹ applies a somewhat different docking technique that involves identifying vantage points from which two ligands look similar. One ligand's frame of reference is shifted to overlay the corresponding vantage points, then rotated to bring the corresponding features into alignment. Further optimization is obtained by relaxing the molecules in the context of a suitably augmented molecular force field.

The approaches cited above were developed primarily for aligning pairs of flexible molecules, but often fail to align larger molecular ensembles well. In general, pairwise optimality of alignment is not transitive: if A1 and B1 are optimally aligned configurations of two flexible molecules A and B, and B1 and C1 are optimally aligned configurations of B and a third flexible molecule C, it does not follow that A1 is optimally aligned with C1. Indeed, the optimal aligned pairs may well be A1 :B1, B2: C2 and C3: A3. This basic conundrum is usually sidestepped by picking a single ligand to serve as a template molecule to which all other ligands are aligned. The breadth of solutions obtained can be broadened considerably by considering each ligand in turn as a potential template, as is done in the HipHop and HypoGen programs in Catalyst^{12,13} and in the MultiSEAL program.¹⁴

A further limitation of the methods described above involves the trade-off between steric and pharmacophoric overlaps. In some cases, strain energy is also considered, directly (in GASP) or indirectly by filtering out high-energy conformers during pre-processing. It is rarely the case that the optimal configurations with respect to all criteria coincide, so getting a single solution requires specifying the relative cost of deviation from the respective optima—i.e., specifying how much a mismatch in sterics “costs” with respect to a mismatch in pharmacophoric features or electrostatics and internal energy. GASP has recently been modified to use a truly multi-objective fitness function, a modification that allows independent optimization of each criterion simultaneously.¹⁵

### DESCRIPTION OF FIGURES

FIG. 1A shows how standard cross-over works for torsional chromosomes encoding two parent models to produce two children.

FIG. 1B shows how cross-over works with variable indexing when the maternal index is used thereby producing two daughters.

FIG. 1C shows how cross-over works with variable indexing when the paternal index is used thereby producing two sons.

FIG. 2 shows an example data set of seven endothelin antagonists drawn from a data set compiled at Bristol-Myers Squibb Pharmaceutical Research Institute.¹⁶

FIG. 3 shows time courses for GALAHAD runs using the ligands shown in FIG. 2 and four different random number seeds. Panels A, B and C show the best individual energy, steric and H-bond scores at each generation, whereas panels D, E and F show the respective scores for the model with the “best” overall score using the tie-breaking method described above.

FIG. 4 shows a plot of the final models obtained for the GALAHAD runs upon which FIG. 3 is based in terms of the models' steric, H-bond and mol. query scores. All points have a Pareto rank of 0 when the fourth criterion—average energy—is taken into consideration. Different symbol shapes correspond to different random number seeds. Note the overlap in Pareto frontiers for the various runs.

FIG. 5 shows that similar models are obtained from the runs made using different random number seeds.

FIG. 6 shows a plot of calculated vs observed potencies for the model based on even-numbered actives.

### DESCRIPTION OF THE INVENTION

The need for a template or base molecule results from the need to compare molecular configurations. In this patent document it is shown that this requirement can be lifted by handling the components of configuration—conformation versus rotation and translation in three-dimensional space—separately. The internal coordinate (torsional) space is explored first using a multi-objective genetic algorithm to minimize strain while maximizing steric and pharrnacophoric concordance. Multiplet maps for the corresponding features are used to evaluate the degree of steric and pharmacophoric consensus; this avoids identifying any single feature in one molecule with any particular feature in another molecule. Rather, it is the overall patterns of feature placement within each molecule that are compared.

Optimal overlays in Cartesian space can then be obtained by applying a 3D hypermolecule construction program that makes use of linear assignment to identify optimal feature correspondences between ligands (LAMDA: Linear Assignment for Molecular Database Alignment). The program was originally developed to operate on atoms,¹⁷ but the version used here has been extended to operate on features instead. The retention by each hypermolecule of all of the information from its constituent molecules makes it possible to build up a full model agglomeratively. Again, no single molecule serves as template; rather, each molecule is allowed to “see” every other molecule. The hyperfeatures generated during model construction are then used to construct final pharmacophoric hypotheses. The complexity of each query reflects the Cartesian concordance of the models from which it is deduced, and the models rescored to reflect this.

In this patent document the sequential application of optimization in internal coordinate and Cartesian spaces is referred to as a Genetic Algorithm with Linear Assignment for Hypermolecular Alignment of Datasets (GALAHAD).

Preprocessing Steps

Ligand structures are read into SYBYL from the Protein Data Bank files¹⁸ in those cases where the specified crystal structures are available. Bond orders are edited manually as appropriate, and the structures relaxed using the Tripos force field.¹⁹ Where no crystal structure is available, structures are sketched into SYBYL²⁰ and CONCORD²¹ is used to generate standardized 3D coordinates. In cases where CONCORD fails or is inappropriate (e.g., due to complex protonation states), structures are minimized using the Tripos or MACROMODEL force field. For ligands with flexible rings, multiple conformers of the rings are obtained using CONFORT²² or, where symmetry supports doing so, by manually applying the necessary transformations. Ligands with multiple base structures are read into GALAHAD in multi-mol2 format to accommodate ring flexibility and stereoinversion at nitrogen. Use of multiple base structures can also be used to account for ambiguities involving protonation and deprotonation as well as tautomerism. It should be noted, however, that the standard feature definitions used in UNITY 3D searching already take these latter effects into account for most common substructures—protonation of non-acylated amidines and alkyl amine s, deprotonation of carboxylic and phosphoric acids, azole tautomerism, etc.

Provision is made for supplying externally generated torsional profiles in multi-mol2 format. In general, however, torsional profiles are obtained for all rotatable bonds in every ligand molecule by extracting torsions from relaxed random conformers. This is accomplished by setting each torsion to an angle drawn at random from a uniform population of angles between 0 and 2π radians, then relaxing the perturbed structure to the nearest local energy minimum. Once this operation had been repeated 100 times, the values obtained for each rotatable bond in all relaxed conformers are sorted to form a torsional bias file for each bond.

In cases where multiple base conformers are supplied, only the first base structure is used to generate the torsional profile. The initial population (zero^{th} generation) for the genetic algorithm is drawn at random from among the randomized conformers.

Individual ligand molecules can be frozen if desired, so that their torsions do not change as the GALAHAD run progresses. Alternatively, an external model can be supplied that consists of a single template molecule or a set of aligned molecules, or a UNITY query, or some combination thereof.

The Genetic Algorithm

The genetic algorithm used by GALAHAD operates on a population of individual models, wherein each model is defined by three chromosomes. Genes in the T chromosome encode the torsional angles for the rotatable bonds in each ligand. Each torsional gene has two parts. The first part is an index i into the torsional profile for the corresponding rotatable bond, and is treated as a circular specification—i.e., the last position is “next to” the first. The second part is a perturbation term that indicates the distance across the gap between that i^{th} torsion and the i+1^{st} torsion in the profile. Taken together, these allow for complete flexibility about every rotatable bond while favoring values that are near energy minima in some conformation.

Combinations of torsions from different minimized structures may, of course, result in more or less severe steric clashes. The secondary perturbation term allows structures to relax and relieve the clash in most such cases. Both parts are interpreted as 256-bit Gray codes, so that flipping any single bit results in a change in torsion that has a pseudo-Gaussian change—usually small but occasionally substantial.²³ Mutating these genes involve entails making just such an inversion at random at a user-specified rate. Each gene is considered independently and in turn with an equal probability of the change being made to the primary or secondary part of that gene. Unless otherwise indicated, the default rate of 0.2 per generation per gene is used for the results described here,

A second, C chromosome specifies the base conformers for each ligand to which the torsions specified by the t genes are to be applied. The default mutation rate for these genes is 0.05, which is generally increased to 0.2 when multiple base conformers are being considered. Mutation in this case entailed selecting a new index—which could be the same as the current index—at random.

Finally, the Q chromosome encodes a 3D UNITY query for the corresponding model. Each gene specifies a feature type; the Cartesian coordinates of the feature centroid; two angles defining the position of the associated site point; and the distance between the feature centroid and that site point. A very wide range of feature types can be defined using the SLN query language²⁴ but five feature types are usually adequate: donor and acceptor atoms and their complementary site points; positive nitrogen and negative centers; and hydrophobic centers. The respective shorthand notations are DA, AA, NP, NC and HY. The feature definitions used here have been modified slightly from those described earlier.²⁵ The nominal site point entries in genes for feature types for which there is no associated site point—positive nitrogens, negative centers and hydrophobic centers—are null placeholder entries.

The GA is run twice in GALAHAD. For the first run, the Q chromosome is filled with null (placeholder) genes. Once the initial run is complete, the set of ligand conformers specified by the t and c genes for each model are aligned in Cartesian space (see below) and the query deduced from that alignment is written into the corresponding chromosome, with null placeholder genes added as needed to fill out the maximum number of genes allowed (here, ten). The GA is then “run” again, this time for zero generations, simply to rescore the models.

Variable Indexing

The order of genes in torsional GAs is generally fixed, since each torsion must be specified and a one-to-one correspondence between genes and rotatable bonds must be strictly maintained. This can limit their optimization power because it prevents the build-up of schema—sets of genes whose optimal values are interdependent that segregate together—as the GA progresses; the degree of linkage between any pair of genes is set by the (arbitrary) order of genes on the chromosome and how complex (single-point, two-point, etc) crossover operations are.

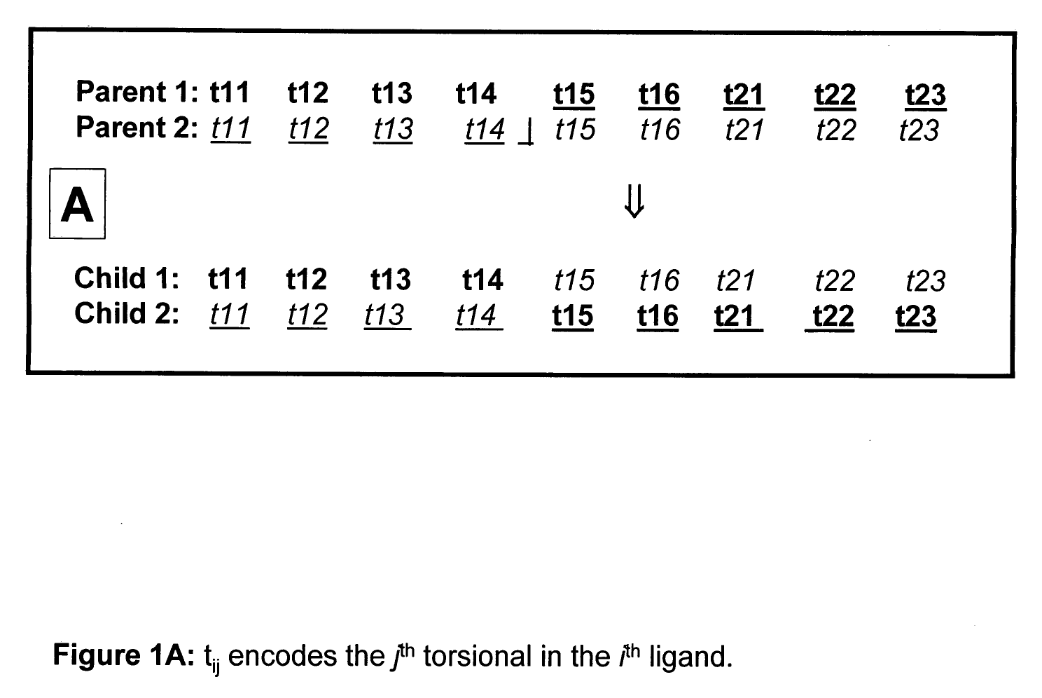

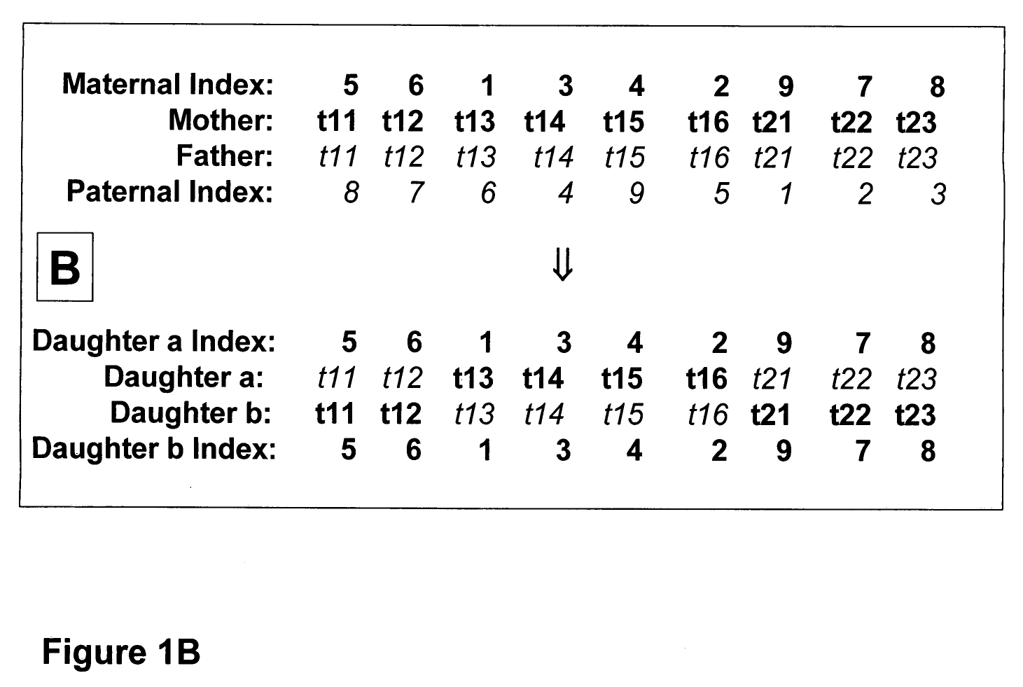

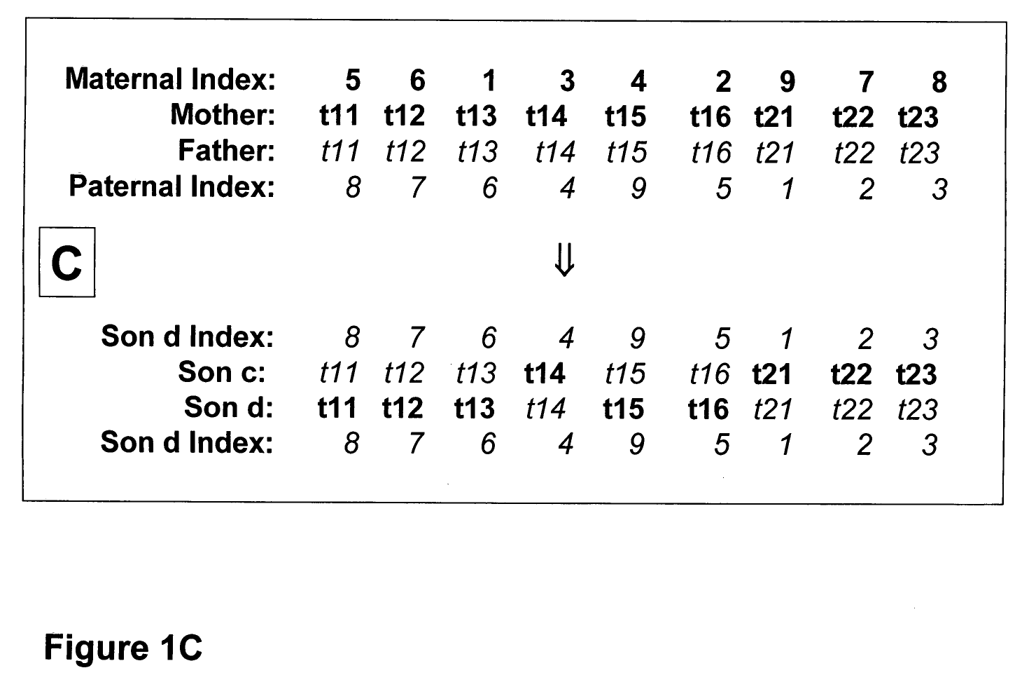

An ordinary single-point crossover is defined on two parents and a randomly chosen gene in a chromosome. Two children are generated, one inheriting the selected gene and those that precede it from one parent, and the genes that follow the selected gene from the other. A second child is generated from the initial genes from the second parent and the terminal block of genes from the first (FIG. 1A).

In variable indexing, each gene is assigned a unique index that can (and usually does) differ from individual to individual. For a torsional GA, it is usually a good idea to group the indices by compound, so that the gene indices for all torsions within any single molecule fall within the same block. The blocks themselves—the virtual order of the molecules—can be arranged in any order.

FIGS. 1B and 1C illustrates how crossover works when variable indexing is turned on. Because the index vectors for the two parents generally differ, mating produces four children rather than the two offspring obtained with an ordinary crossover. One crossover takes place based on the index vector u of one parent (the “mother”), and a second takes place based on the index vector v of the other (the “father”). A crossover index value ηᵢ is selected at random, then a maternal gene i is inherited by the first child if the corresponding maternal gene index uᵢ is less than or equal to ηᵢ, and by the second child if uᵢ>ηᵢ. Conversely, a paternal gene j is inherited by the first child if uᵢ>ηᵢ, and by the second child if uᵢ≦ηᵢ. This first pair of offspring (the “daughters”) inherit the maternal index vector u (FIG. 1B).

The second pair of offspring (the “sons”) are generated similarly, but based on the paternal index vector v. Maternal genes i for which vᵢ≦ηᵢ are inherited by the third child, whereas those for which vᵢ>ηᵢ are inherited by the fourth child. Paternal inheritance is complementary, and the offspring produced by the second crossover operation (the “sons”) inherit the paternal index vector v (FIG. 1C).

Heterosexual reproduction can be enforced by maintaining segregation of the parental pools by sex, by requiring that any two parents that mate be drawn from separate populations, and by returning the children produced to the parental population of the corresponding sex. Note that the number of sexes need not be limited to two. In this patent disclosure, a single (hermaphroditic) population is considered, but there is reason to expect that differentiated sexes —e.g., one population initially comprised of individuals with indices in their “natural” order and another with scrambled indices—will afford superior performance in some circumstances.

The index vectors themselves can undergo two types of mutations. Pairs of genes on the C or Q chromosome can swap indices, as can torsional genes on the T chromosome, provided only that they code for torsions in the same ligand. These mutation rates are specified on a pergene basis, with a default mutation rate of 0.05. A second class of mutation swaps the indices for blocks of t genes from different ligands. Swaps of blocks are applied independently of swaps within blocks at a rate specified on a per-chromosome basis. For the applications disclosed in this patent document, this rate is 0.0—indices are scrambled initially within blocks, as are block orders, but there is no interchange of blocks in subsequent generations. Clearly higher rates may be advantageous for use with other data sets.

Crossovers and Mutations

Crossovers are applied separately to each chromosome. Unless otherwise indicated, the crossover rate is set to 1.0 for all three chromosomes, so that every virtual mating resulted in a crossover. Two-point crossovers are used by default. Note, however, that the first or last gene could be selected as a crossover point, which is equivalent to a single-point crossover. It is also possible to select the same gene for both crossover points, which results in no net change in the chromosome.

Selection for reproduction is carried out by roulette-wheel selection. The likelihood of a model's reproducing once in each generation is made proportional to 1/(r+1), where r is equal to the Pareto rank.^{26, 27} The Pareto rank of a model is simply the number of candidate models by which it is dominated—i.e., the number of models that are better than it is by all criteria under consideration.²⁸ The criteria in the first pass through the GA are the average energy and the concordances among the steric and pharmacophoric (“H-bond”) multiplets.²⁹

In the initial embodiment disclosed in this patent document, no attempt was made to prevent the same individual being selected as the first and second parent. In an alternative embodiment, a constraint may be imposed that prevents the same individual being selected as both the first and second parent. This may prevent premature convergence for some data sets.

The nominal rank of each individual is increased by one after each selection for reproduction in each generation, which reduces the risk of premature convergence. Hence the reproductive roulette wheel sector for each undominated individual (Pareto rank r=0) is initially set to an area of 1/(0+1)=1. It is reduced to 1/(0+1+1)=0.5 if that individual is chosen as a parent once, to 0.333 after a second selection, and so forth. No individual is represented more than once in the tournament for any generation.

Mutations are applied after all crossover operations are complete.

Fitness Criteria

Torsional and van der Waals energies for each candidate model are evaluated using the Tripos force field. Multiplet features are based on standard feature definitions. The “flavor” of multiplets used can be modified to suit the needs of any particular dataset, but the default choices—steric quartets and pharmacophore triplets—work well in most cases, and are fast. Alternatives include augmented pharmacophore triplets (which incorporate the site points from donor and acceptor atoms) and inclusion of positive nitrogens and negative centers as privileged substructures (anchor points) for orienting steric triplets.³⁰

Multiplet concordances are assessed using a χ² statistic that employs a strong continuity correction. Separate steric and pharmacophoric multiplet bitmaps are created for the specific conformation of each molecule in the model. The corresponding (compressed) count vectors are then created, each element indicating the number of ligands in which the corresponding multiplet is found for the model being evaluated. The steric and pharmacophoric concordances σ and φ are then given by (Eqn 1):

$$\begin{matrix}σ = \frac{1}{{n}^{2}} {( \sqrt{{\sum }_{{s}_{i} > 1} {( {s}_{i} + {\ddot{s}}_{i} )}^{2}} - \sqrt{{\sum }_{{\ddot{s}}_{i} > 1} {\ddot{s}}_{i}^{2}} )}^{2} & ( Eqn . 1 ) \\ φ = \frac{1}{{n}^{2}} {( \sqrt{{\sum }_{{h}_{i} > 1} {( {h}_{i} + {\ddot{h}}_{i} )}^{2}} - \sqrt{{\sum }_{{\ddot{h}}_{i} > 1} {\ddot{h}}_{i}^{2}} )}^{2} & ( Eqn . 2 )\end{matrix}$$

where sᵢ and hᵢ represent the elements of the model's steric and pharmacophoric (H-bond) count vectors, respectively, and \ddot{s}ᵢ and \ddot{h}ᵢ represent the elements of the template count vectors generated from the external model. Scaling by n² (where n is the number of ligand molecules in the dataset) and correcting for the template contributions do not affect the course of the GA, but they do make it easier to compare scores across datasets.

Note that singleton elements (sᵢ=1 and fᵢ=1) are omitted from the summation. This continuity correction corresponds to the null hypothesis expectation that all elements will be zero or one—i.e., that there will be no concordance at all. This is an approximation, since there is a finite chance of getting counts above one at random, but the multiplets being used are sparse enough that this is not a major concern.

A fourth criterion is included when an external template query is supplied. It is also calculated for the second, zero-generation pass for re-scoring models obtained from a naïve run. This molecular query (mol. query) term μ reflects the degree of concordance between the query and the pharmacophoric multiplets for the molecules being aligned.

$$μ = \sum \vert {p}_{i} ⋃ {\ddot{p}}_{i} \vert \times {h}_{i}^{2} - {\sum }_{{h}_{i} = 0} \vert {p}_{i} ⋃ {\ddot{p}}_{i} \vert \times w \qquad ( Eqn . 3 )$$

where pᵢ are the elements of the bitmap for the model query and \ddot{p}ᵢ are the elements of the bitmap for the template query. The union symbol (∪) indicates that the value within the brackets is 1 if the i^{th} element is set in either bitmap and 0 otherwise. The penalty term w is set to 0.1 by default.
Selection

Mating and mutation are continued until a tournament pool twice the specified size of the population is in hand, with the default population size being 10n or 120, whichever is less. Candidates are then selected for inclusion in the next generation based on their Pareto rank. Unfortunately, the need to break ties in Pareto rank often arises quite early in the course of the GA. Ties are resolved by stepping down through a hierarchy of criteria defined by the “weight” classes to which the various terms had been assigned, with an assigned weight of 0 serving as a flag that the criterion should be ignored altogether in calculating the Pareto rank.

By default, the weight for energy is set to 0.8 and the weights for the steric and H-bond weights are both set to 1.0. No query is present to consider for naive GA runs, so the weight for the mol.query term is set to 0.0 in that case. Hence ties in Pareto rank are broken where necessary by comparing the sums of the steric and H-bond ranks, and ties not resolved on that basis are addressed by comparing the energy ranks.

Oedipal selection is used to decide which models should make up the next generation, with parents and children both participating in the tournament. In the event of a tie in the fitness function between any two models, the elder individual is favored over any “child” model. Elitism is applied as well, which guarantees that the most fit individuals in each generation—“most fit” by any one criterion or overall—are included in the pool of tournament candidates even if they were not chosen as parents.

When rescoring models, the mol. query weight is set to 1.0, so that ties in Pareto rank are resolved by taking the rank sum across all three criteria in that weight class—steric, H-bond, and mol. query score. In the experience of the inventors, different mol. query weights are appropriate when aligning single molecules to a template than are appropriate for aligning ensembles to a template; in the former case, a weight of 1.1 is used, whereas a weight of 0.9 tends to work better in the latter case.

Hypermolecular Alignment

Once a set of compatible conformers has been generated by the GA, a dendrogram is constructed from the pairwise similarities between their pharmacophore multiplet bitmaps; complete linkage agglomerative clustering^{31,32} is used in the analyses described in this patent disclosure. Corresponding features in each basal pair of similar ligands A and B can then be identified using a linear assignment approach to minimize the total cost c given by³³:

$$\begin{matrix}c = {\sum }_{i} [ α ( \vert γ ( {a}_{i} ) - γ ( {b}_{i} ) \vert ) + \frac{1}{{β}_{i}} {\sum }_{j} {\sum }_{k} \frac{{( {λ}_{jk} ( {a}_{i} ) - {λ}_{jk} ( {b}_{i} ) )}^{2}}{{λ}_{jk} ( {a}_{i} ) + {λ}_{jk} ( {b}_{i} )} ] & ( Eqn 4 ) \\ {β}_{i} = {\sum }_{j} {\sum }_{k} ( {λ}_{jk} ( {a}_{i} ) + {λ}_{jk} ( {b}_{i} ) ) & ( Eqn . 5 )\end{matrix}$$

where γ(aᵢ) is the GASP weight (interaction strength) specified in the macro definitions file for feature aᵢ in A and γ(bᵢ) is the GASP weight for the corresponding feature bᵢ in B; only correspondences between features of the same type are considered. The triple summation gives the χ² dissimilarity between the respective neighborhoods, calculated from the radial distribution functions for relevant features. These are calculated for 1 Å layers j around each feature out to a maximum distance of 20 Å, with a separate distribution function for each relevant feature type k. The configuration files used define neighborhoods for hydrophobic features in terms of donor and acceptor atoms, positive nitrogen and negative centers as well as other hydrophobic centers. Neighborhoods for other feature types are defined in terms of the distribution of steric features, but more elaborate descriptions of neighborhoods may be used.

Making symmetrical substitutions is a powerful tool in drug discovery and lead optimization, but the degeneracy it introduces can complicate identifying correspondences. Problematic “mirror features” are identified by comparing each molecule to itself and features in intramolecular correspondences that have low matching costs are then set aside when making intermolecular comparisons. Their correspondences can be revisited if too few good correspondences survive subsequent filtering steps. Note: because only local equivalence matters, only five 1 Å layers in the radial distribution function are considered for identifying mirror features.

Once an optimal set of intermolecular correspondences has been identified, those with large costs are set aside, leaving reduced feature sets A′ and B′. Intramolecular distance matrices D(A′) and D(B′) indexed by correspondence are then set up for each molecule, and the elements are compared to check for geometric consistency. If two sets of correspondences (a₁,b₁) and (a₂,b₂) are both going to be useful for alignment, then the distance between a₁ and a₂ in A′ needs to be close to the distance between b₁and b₂ in B′. Outliers are identified by examining the row and column totals in the delta matrix Δ(A′,B′)=D(A′)−D(B′); outlier correspondences are set aside in sequence until the remaining elements in the delta matrix are acceptably small.

If the reduced feature sets A″ and B″ include too many correspondences (ten for the analyses described here), they are subjected to a final geodesic filtering step to identify those features that have the greatest geometric leverage. The first features picked are those that lie farthest from the Cartesian centroids of A″ and of B″. The list is then built up to the specified limit by iterative addition of those features that have the largest minimum spatial separation from those already on the list.

If too few correspondences (here, fewer than three) remain in the reduced molecules A″ and B″ after these filtering steps, alignment has failed and the molecule having the most features is returned.

Otherwise, the remaining correspondences represent a mapping A″→B″ that defines a least-squares optimal transformation (rotation and translation) that overlays the full molecule A onto B. The initial overlay so obtained is refined by cycling through the entire process twice more. Only steric features are considered for these refinement steps, and Euclidean distance serves as the cost function for the linear assignment step. Geometric filtering is based on an externally specified distance cutoff—here, 1.0 and 1.2 Å for the first and second refinement cycles, respectively.

A hypermolecule can then be created from each pair of successfully overlaid molecules. Atoms retain their individual identity but features of the same type that lie closer together than a threshold distance of 0.6 Å are consolidated into a single hyperfeature. Other averaging thresholds can also be used.

The hypermolecules produced from the basal molecule pairs correspond to the first-level nodes in the clustering dendrogram. Aligning these with each other (or with single molecules) proceeds exactly as described above for pairs of single molecules, except that a more complex version of the cost function is used that favors correspondences between “large” hyperfeatures as shown below as (Eqn. 6):

$$\begin{matrix}c = {\sum {ω}_{i}}_{i} [ {α}_{0} \vert 〈 γ ( {a}_{i} ) 〉 - 〈 γ ( {b}_{i} ) 〉 \vert + {α}_{1} {min}_{j , k} \vert γ ( {a}_{ij} ) - γ ( {b}_{ik} ) \vert \frac{1}{{β}_{i}} {\sum }_{j} {\sum }_{k} \frac{{( {λ}_{jk} ( {a}_{i} ) - {λ}_{jk} ( {b}_{i} ) )}^{2}}{{λ}_{jk} ( {a}_{i} ) + {λ}_{jk} ( {b}_{i} )} ] & ( Eqn 6 ) \\ {ω}_{i} = \frac{‖ A ‖}{‖ {a}_{i} ‖} + \frac{‖ B ‖}{‖ {b}_{i} ‖} & ( Eqn . 7 ) \\ {β}_{i} = {\sum }_{j} {\sum }_{k} ( {λ}_{jk} ( {a}_{i} ) + {λ}_{jk} ( {b}_{i} ) ) & ( Eqn . 8 )\end{matrix}$$

In these equations, aᵢⱼ and bᵢⱼ are the component features that make up hyperfeatures aᵢ and bᵢ, and angle brackets indicate averaging across the respective individual features. It should be noted that the radial distribution bin counts λⱼₖ are weighted by the size (cardinality) of each neighboring hyperfeature. The double vertical bars denote cardinality, i.e., the number of individual features or molecules contributing to the bracketed hypermolecule or hyperfeature.

The hypermolecule itself ordinarily provides the structural components of the final model, unless a template structure has been provided. In the latter case, the final hypermolecule (or molecule, in the case of one-by-one alignment) is fitted back to the template (hyper)molecule.

Atom based alignment constitutes a special case. Each heavy atom represents a feature in and of itself, and partial atomic charges replace atom weights. The final hypermolecule then consists of hyperatoms as well as atoms in a single connection table. In this case, the ligands are aligned individually to the final hypermolecule to maintain the integrity of the individual connection tables.

Query Generation

Once alignment is complete, individual features are regenerated for each component substructure in the hypermolecule and clustered by assignment to the nearest hyperfeature of the same type, provided that the candidate hyperfeature is close enough. “Close enough” is defined as a Euclidean distance less than 1.2 times the specified initial tolerance threshold, with 1.0 Å serving as the default value for the work described here. Query features are then centered between the extreme coordinate values for each cluster whose population exceeds the minimum number of molecules tₘᵢₙ required to “hit”. This threshold is specified separately for each analysis, with a value of √n rounded up to the nearest whole number generally serving as a good starting point. Larger values may be needed for pharmacophorically complex ligands or large datasets. The tolerance for each query feature is set to the maximum distance between that feature and any of the features in the cluster it represents.

Flexible 3D search queries generally need some “fuzziness” in the form of partial match constraints if they are to be both specific and discriminating, but no single constraint is typically optimal. The inventors have observed that having two constraints—a “tight” one where most or all features are required and a “loose” one where relatively few features are required—works well in most cases. To this end, query features qᵢ that “hit” at least tₘᵢₙ ligands are allocated to partial match constraints by applying the following method:

Suppose that clusters of query features have been sorted in decreasing order of how many features they contain—i.e., of how many of the n ligands in a hypermolecule they “hit.” Suppose further that one wishes to distribute the features in such a way that features hitting the same number of ligands fall under the same partial match constraint. Then the feature centroids qᵢ representing the clusters i=1,2, . . . can be allocated among partial match constraints in the query by applying the following method:
1. let k(qᵢ) be the number features in the cluster represented by qᵢ—i.e., the number of ligands that hit query feature q_{i;}
2. drop any qᵢ for which k(qᵢ) <t_{min,} where tₘᵢₙ is the minimum number of ligands that each query feature must “hit.”
3. initialize the partial match sets q₂ and q₁ as empty sets;
4. if the number of features |qᵢ|<5, set qᵢ={qᵢ} and go to Step 15;
5. set t=max(k(qᵢ));
6. if k(qᵢ)=t, add qᵢ to q₁;
7. set t=t−1;
8. if t<min(tₘᵢₙ, 0.75 n), go to step 15;
9. if the cardinality |qᵢ|<3 and some features qᵢ have not been assigned, go to step 6:
10. if k(qᵢ)=t, add qᵢ to q₂;
11. set t=t−1;
12. if t<tₘᵢₙ, go to step 14;
13. if |q₁|+|q₂|<8, go to step 10;
14. if |q₂|=1 and |q₁|=3, set q₁=q₁∪ q₂ and set q₂ equal to the empty set;
15. if |q₁|≦3, mark all qᵢ in q₁ as required matches and go to step 18;
16. if |q₁|=4:
   a. if k(qᵢ)=n for any qᵢ in q₁, mark all qᵢ in q₁as required matches and go to step 18; else
   b. set the minimum partial match for q₁ (min₁) to 3 and go to step 18;
17. if |q₁|>4, set min₁=4;
18. set min₂ as follows:
   a. min₂=0 if |q₂|=1;
   b. min₂=1 if |q₂|=2;
   c. min₂=2 if |q₂|=3;
   d. min₂=5−min₁ or to 2, whichever is greater, if |qhd 2|>3.
      Example Application

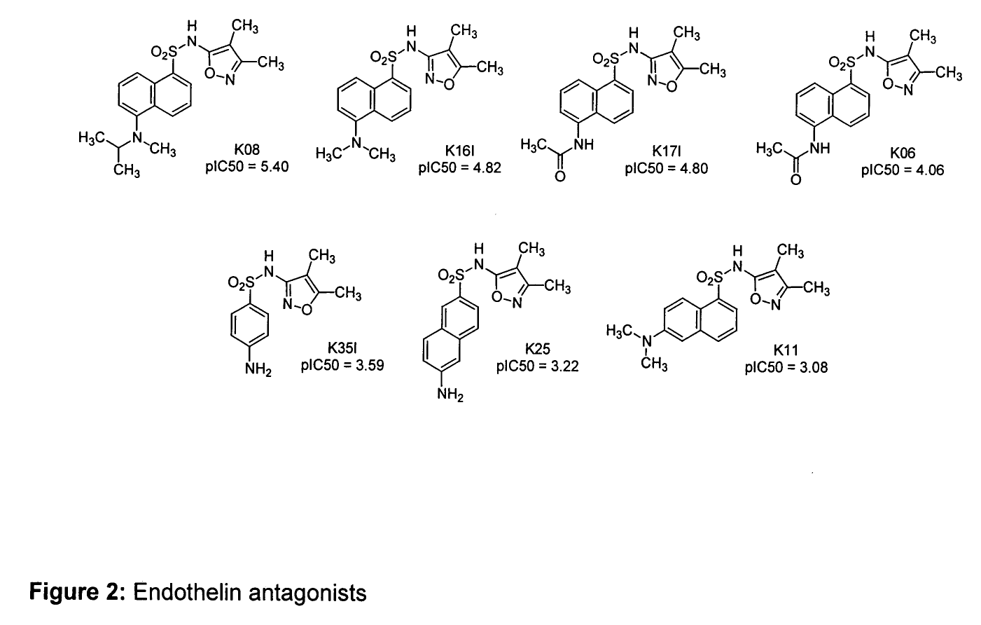

Seven active endothelin antagonists were drawn from a data set compiled at Bristol-Myers Squibb Pharmaceutical Research Institute (FIG. 2).

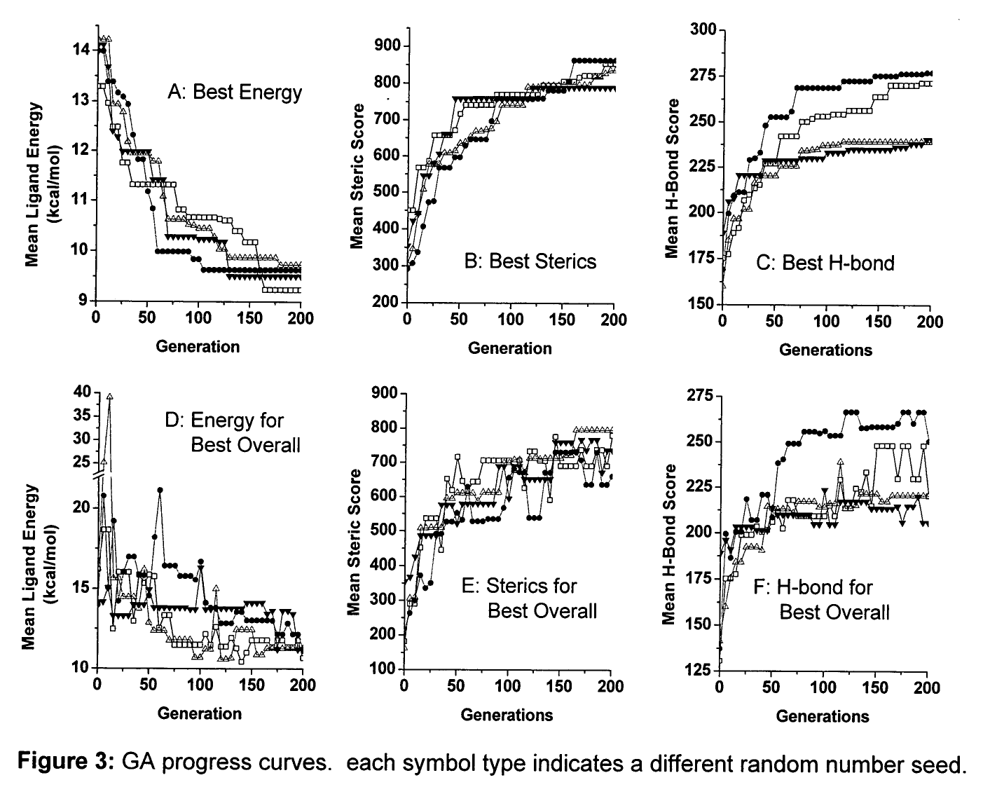

FIG. 3 shows time courses for GALAHAD runs using the ligands shown in FIG. 2 and four different random number seeds. Panels A, B and C show the best individual energy, steric and H-bond scores at each generation, whereas panels D, E and F show the respective scores for the model with the “best” overall score using the tie-breaking method described above.

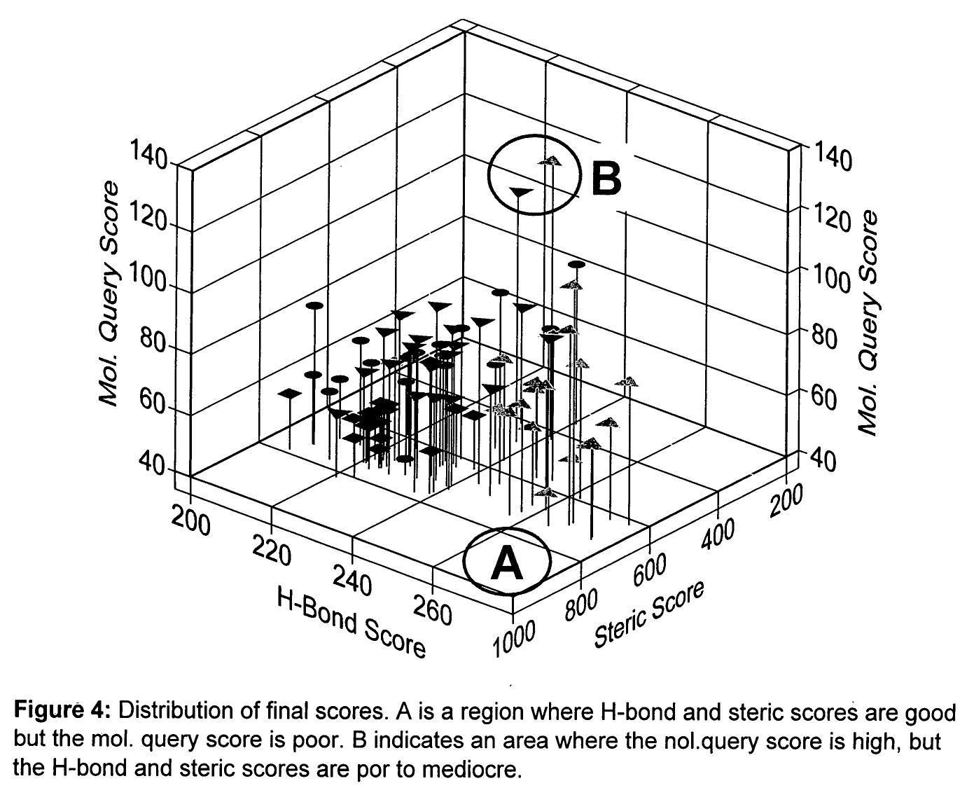

FIG. 4 shows a plot of the final models obtained for the GALAHAD runs upon which FIG. 3 is based in terms of the models' steric, H-bond and mol. query scores. All points have a Pareto rank of 0 when the fourth criterion—average energy—is taken into consideration. Different symbol shapes correspond to different random number seeds. Note the overlap in Pareto frontiers for the various runs.

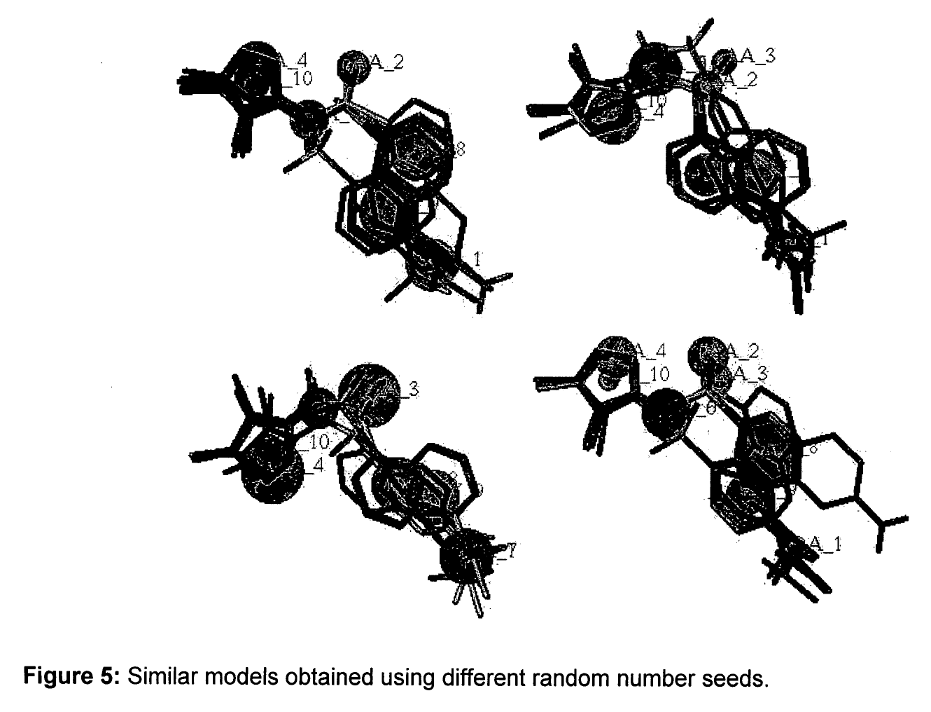

FIG. 5 shows that similar models are obtained from the runs made using different random number seeds.

The full endothelin antagonist dataset was sorted by potency, and GALAHAD models were obtained from the odd- (1^{st}, 3^{rd}, 5^{th} etc) and even-ranked actives (i.e., those with pIC50<1 μM). All 36 compounds were then aligned individually to each model using GALAHAD, and the potencies (pIC50 values) were regressed on the individual scores. The summary statistics obtained were:

For the model constructed from odd-ranked actives:

| | Components: | | | |
|---|---|---|---|---|
| | 1 | 2 | 3 | 4 |
| Standard Error of Prediction: | 738.2 | 658.6 | 672.6 | 655.9 |
| Crossvalidated R²: | 0.593 | 0.686 | 0.682 | 0.707 |

Equation @ 2 components: 1000 * pIC50 = 1803 − 31E + 0.26ST + 3.7 * HB + 17.8MQ
Standard Error of regression: 594.7;
Regression R²: 0.744

For the model constructed from even-ranked actives:

| | Components: | | | |
|---|---|---|---|---|
| | 1 | 2 | 3 | 4 |
| Standard Error of Prediction: | 835.7 | 837.4 | 860.1 | 857.9 |
| Crossvalidated R²: | 0.479 | 0.492 | 0.481 | 0.499 |

Equation @ 2 components: 1000 * pIC50 = 1976 − 18E + 0.54ST + 3.3 * HB + 4.2MQ
Standard Error of regression: 762.0;
Regression R²: 0.580

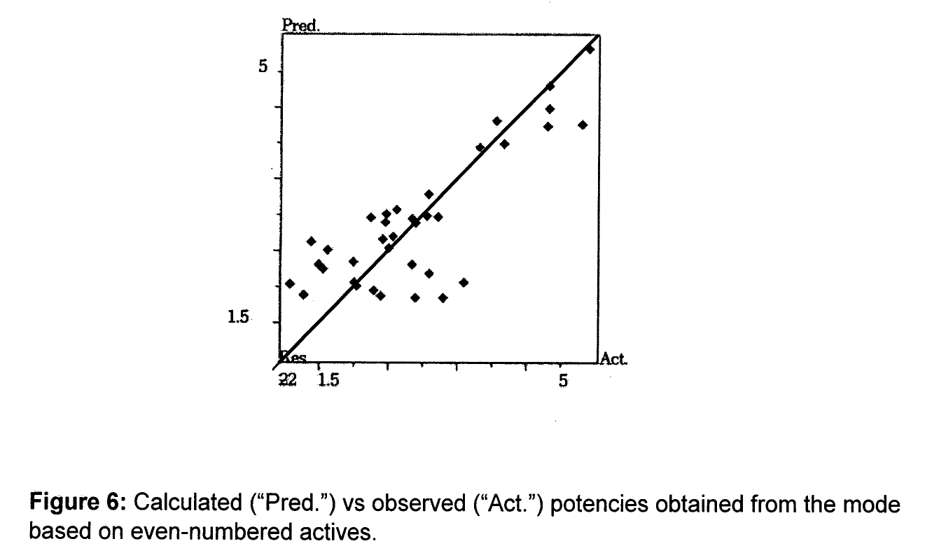

Note that the predictivity is quite good, especially given the non-linearity suggested by the somewhat low standard errors of regression. Note, too, that qualitatively very similar results were obtained for the two different training sets. FIG. 6 shows a plot of calculated vs observed potencies for the model based on even-numbered actives.

### REFERENCES

¹Pharmacophore Perception, Development, and Use in Drug Design, Güiner, O., Ed.; International University Line, La Jolla, 1999.
² Lemmen, C., Lengauer, T. Computational methods for the structural alignment of molecules. J. Comput.-Aidede Mol. Des. 2000, 14, 215-232.
³ Patel, Y., Gillet, V., Bravi, G., Leach, A. R. A comparison of pharmacophore identification programs: Catalyst, DISCO and GASP. J. Comput.-Aided Mol. Design 2002, 16, 653-681.
⁴ Martin, Y. C. Distance comparisons (DISCO): A new strategy for examining 3D structure-activity relationships. In: Classical and 3D QSAR in Agrochemistry (ACS Symposium Series 606), Hansch, C., Fujita, T., Eds.; American Chemical Society, Washington DC, 1995; pp. 318-329.
⁵DISCO is distributed by Tripos, Inc., 1699 S. Hanley Road, St. Louis Mo. 63141 USA.
⁶Jones, G., Willett, P., Glen, R. C. A genetic algorithm for flexible molecular overlay and pharmacophore elucidation. J. Comput.-Aided Mol. Des. 1995, 9, 532-549.
⁷Kearsley, S. K., Smith, G. M. An alternative method for the alignment of molecular structures: maximizing electrostatic and steric overlap. Tetrahedron Comput. Methods 1990, 3, 615-633.
⁸Klebe, G., Mietzner, T., Weber, F. Different approaches toward an automatic structural alignment of drug molecules: application to sterol mimics, thrombin and thermolysin inhibitors. J. Comput.-Aided Mol. Des. 1994, 8, 751-778.
⁹Clark, M., Cramer, R. D. III, Jones, D. M., Patterson, D. E., Simeroth, P. E. Comparative molecular field analysis (CoMFA). 2. Toward its use with 3D structural databases. Tetrahedron Comput. Methods 1990, 3, 47-59.
¹⁰Lemmen, C., Lengauer, T., Klebe, G. FlexS: A method for fast flexible ligand superposition. J. Med. Chem. 1998, 41, 4502-4520.
¹¹Jain, A. J. Ligand-Based Structural Hypotheses for Virtual Screening. J. Med. Chem. 2004, 47, 947-961.
¹²Barnum, D., Greene, J., Smellie, A., Sprague, P. Identification of common functional configurations among molecules. J. Chem. Inf. Comput. Sci. 1996, 36, 563-571.
¹³Li, H., Sutter, J., Hoffman, R. HypoGen: An Automated System or Generating 3D Predictive Pharmacophore Models. In: Pharmacophore Perception, Development, and Use in Drug Design, G üner, O., Ed.; International University Line, La Jolla, 1999; pp. 171-189.
¹⁴Feher, M., Schmidt, J. M. Multiple flexible alignment with SEAL: a study of molecules acting on the colchicines binding site. J. Chem. Inf. Comput. Sci. 2000, 40, 495-502.
¹⁵Cottrell, S. J., Gillet, V. J., Taylor, R., Wilton, D. J. Generation of multiple pharmacophore hypotheses using multiobjective optimization techniques. J. Comput.-Aided Mol. Des. 2004, 18, 665-682.
¹⁶Richmond, N. J., Willett, P., Clark, R. D. Alignment of three-dimensional molecules using an image recognition algorithm. J. Mol. Graph. Model. 2004, 23, 199-209.
¹⁷Berman, H. M., Westbrook, J., Feng, Z., Gilliland, G., Bhat, T. N., Weissig, H., Shindyalov, I. N., Bourne, P. E. The Protein Data Bank. Nucleic Acids Research 2000, 28, 235-242; http://www.rcsb.org/pdb.
¹⁸Clark, M., Cramer, R. D. III., Van Opdenbogch, N., J. Comp. Chem. 1989, 10, 982.
¹⁹SYBYL is distributed by Tripos, Inc., 1699 S. Hanley Rd., St. Louis Mo. 63144 USA
²⁰CONCORD® was developed by R. S. Pearlman, A. Rusinko, J. M. Skell and R. Baducci at the University of Texas, Austin, and is distributed exclusively by Tripos, Inc., 1699 S. Hanley Rd., St. Louis Mo. 63144.
²¹CONFORT® was developed by R. S. Pearlman and R. Balducci at the University of Texas, Austin, and is distributed by Tripos, Inc., 1699 S. Hanley Rd., St. Louis Mo. 63144.
²²Gray, F. Pulse Code Communications, U.S. Pat. No. 2632058, March 1953
²³Ash, S.; Cline, M. A.; Homer, R. W.; Hurst, T.; Smith, G. B. SYBYL Line Notation (SLN): A Versatile Language for Chemical Structure Representation. J. Chem. Inf. Comput. Sci. 1997, 37, 71-79.
²⁴Abrahamian, E., Fox, P. C., Naenrum, L., Christensen, I. T., H. Tho gersen H., Clark, R. D. Efficient Generation, Storage and Manipulation of Fully Flexible Pharmacophore Multiplets and their Use in 3-D Similarity Searching. J. Chem. Inf. Comput. Sci. 2003, 43, 458-468.
²⁵Van Veldhuizen, D. A., Lamont, G. B. Multiobjective Evolutionary Algorithms: Analyzing the State-of-the-Art. Evol. Comput. 2000, 8, 125-147.
²⁶Cottrell, S. J., Gillet, V. J., Taylor, R., Wilton, D. J. Generation of multiple pharmacophore hypotheses using multiobjective optimization techniques. J. Comput.-Aided Mol. Des. 2004, 18, 665-682.
²⁷This is slightly at variance with the classical definition, where one candidate dominates another if it is better in terms of at least one criterion and better or tied with respect to all others.
^{28,29} Abrahamian, E., Fox, P. C., Naerum, L., Christensen, I. T., H. Thogersen H., Clark, R. D. Efficient Generation, Storage and Manipulation of Fully Flexible Pharmacophore Multiplets and their Use in 3-D Similarity Searching. J. Chem. Inf Comput. Sci. 2003, 43, 458-468
³⁰Murtagh, F. Comput. J. 1983, 26, 354-359.
³¹Barnard, J. M., Downs, G. M. J. Chem. Inf. Comput. Sci., 1992, 32, 644-649.
³²Richmond, N. J., Willett, P., Clark, R. D. Alignment of three-dimensional molecules using an image recognition algorithm. J. Mol. Graph. Model. 2004, 23, 199-209.
³³Krystek, S. R., Jr., Hunt, J. T., Stein. P. D., Stouch, T. R. Three-dimensional quantitative structure-activity relationships of sulfonamide endothelin inhibitors. J. Med. Chem. 1995, 38, 659-668.

1. A computer-implemented method for aligning flexible molecules in three dimensions comprising the following steps:
a) selecting a conformer of each molecule in a data set such that the selected conformers are concordant in the respective internal coordinate spaces; and
b) aligning in Cartesian space based upon shared molecular spatial characteristics of selected conformers.

2. The method of claim 1 in which the selection in step a is performed by a genetic algorithm that utilizes variable indexing.

3. A method of claim 1 in which the aligned molecules are used to create a pharmacophoric search query.

4. A method of claim 2 in which the aligned molecules are used to create a pharmacophoric search query.
